(19) United States
(12) Patent Application Publication
(10) Pub. No.: US 2011/0071886 A1
(43) Pub. Date: Mar. 24, 2011

(54) SYSTEMS AND METHODS FOR OPTIMIZING ORGANIZATIONAL SPEND

(75) Inventors: Frank E. Schnur, Hopkinton, MA (US); Christa N. Ancri, Potomac, MD (US); David R. Heath, Katy, TX (US); John T. Macko, Alpharetta, GA (US); Suzie E. Jennings, Houston, TX (US); Lydia L. Walsh, New York, NY (US); Pranav Gaur, Noida (IN)

(73) Assignee: American Express Travel Related Services Company, Inc., New York, NY (US)

(21) Appl. No.: 12/652,972

(22) Filed: Jan. 6, 2010

Related U.S. Application Data
(60) Provisional application No. 61/245,189, filed on Sep. 23, 2009.

(51) Int. Cl. G06Q 10/00; G06Q 50/00; G06F 3/14

(52) U.S. Cl. 705/10; 705/348; 705/301; 715/700

(57) ABSTRACT

A system and method is disclosed for modeling, predicting, forecasting, and analyzing organizational spend/procurement, such as travel spend. In various embodiments, a method for modeling, predicting, budgeting, and optimizing business spend and procurement is provided comprising obtaining benchmark data, obtaining opportunity assessment data, obtaining organizational cost data, modeling the opportunity assessment data in comparison to the benchmark data, and determining a potential cost result based on the modeling. The method may further comprise adjusting the opportunity assessment data to achieve a desired cost result.

### CROSS REFERENCE TO RELATED APPLICATIONS

This application is a nonprovisional of U.S. Provisional Patent Application No. 61/245,189, filed on Sep. 23, 2009 and entitled, “SYSTEMS AND METHODS FOR OPTIMIZING ORGANIZATIONAL SPEND.” The '189 provisional application is incorporated by reference herein in its entirety.

### FIELD OF INVENTION

The present invention generally relates to financial data processing, and more particularly, to a system and method for modeling, predicting, forecasting, and analyzing organizational spend/procurement, such as travel spend.

### BACKGROUND OF THE INVENTION

Business performance tuning is important in optimizing spend, and therefore, reducing overall budgets. However, in complex business units (e.g., corporate travel departments), it is often difficult to identify and take advantage of opportunities for spend and/or procurement optimization.

In addition, it is often difficult to predict organizational spend using conventional means. While top-down control of budgets may help control spending for a given period, predicting how spending changes will affect future operations may assist in procurement optimization. Accordingly, a need exists for systems and methods of spend and procurement optimization of a business or business unit.

### SUMMARY OF THE INVENTION

In various embodiments, a method for modeling, predicting, budgeting, and optimizing business spend and procurement is provided comprising obtaining benchmark data, obtaining opportunity assessment data, obtaining organizational cost data, modeling the opportunity assessment data in comparison to the benchmark data, and determining a potential cost result based on the modeling. The method may further comprise adjusting the opportunity assessment data or budget projection to achieve a desired cost result and adjusted KPIs in the scenario analysis.

In various embodiments, an article of manufacture is provided including a computer readable medium having instructions stored thereon that, if executed by a computing device, cause the computing device to obtain benchmark data, obtain opportunity assessment data and model the opportunity assessment data in comparison to the benchmark data.

In further embodiments, a system is provided comprising a dashboard computer having a processor, a memory, and a data store, wherein the dashboard computer is configured to obtain, using the processor, benchmark data, wherein the dashboard computer is configured to obtain, using the processor, opportunity assessment data, wherein the dashboard computer is configured to model, using the processor, the opportunity assessment data in comparison to the benchmark data.

In further embodiments, a method is provided comprising, obtaining benchmark data; obtaining opportunity assessment data, and modeling the opportunity assessment data in comparison to the benchmark data.

### BRIEF DESCRIPTION OF THE DRAWINGS

FIG. 1 illustrates a dashboard showing a divisional spend breakout for a given year in accordance with an embodiment;

FIG. 2 illustrates a dashboard showing various procurement data, policy data, and behavioral data as sliding “bars” that may be adjusted in accordance with an embodiment;

FIG. 3 illustrates a dashboard showing various procurement data by vendor type in accordance with an embodiment;

FIG. 4 illustrates a dashboard showing a “big picture” summary of the various adjustments made in the other portions of the dashboard in accordance with an embodiment; and

FIG. 5 illustrates a data mapping approach in accordance with an embodiment.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Given economic constraints, many “C” level executives (e.g., CFO, CEO, CIO, CPO) are trying to cut travel and expense spend by making targeted decisions that remove excessive spending, but continue to support revenue generating activities, and thus, optimize overall business performance. The systems and methods disclosed herein comprise a planning tool that brings together travel and expense budgeting and spend information with cost reduction opportunities, so that companies may decide how and where to spend their travel budget. In various embodiments, companies may be enabled to implement trade-offs between budget cuts and cost reduction measures based on, for example, an opportunity assessment. Cost reduction measures include, for example, policy changes, behavioral changes, and supplier contract (procurement) improvements. Accordingly, a customized planning tool is provided that enables visibility into travel and expense spend by both business subunit (e.g., department or subsidiary) and business purpose, as well as also providing Key Performance Indicator (“KPI”) comparisons against benchmarks and/or target goals. In various embodiments, dashboards disclosed herein may identify targeted opportunities to optimize savings in order to achieve business objectives.

In various embodiments, a dashboard is provided to give better insight and information to “C” level executives, so that they can make educated, strategic travel cuts. Such cuts may allow them to continue with business generating travel, while reducing non-necessary spend. Accordingly, the systems and methods disclosed herein address the need for building interactive models which identify current spend and behavior patterns, and then allow for identification of various possible outcomes, based on program changes, with minimal intervention from analysts.

In the travel industry, various factors influence an organization's bottom line travel costs. These factors include travel policies, travel behaviors, and procurement relationships, among others. Such factors influence business performance, often as measured by key performance indicators (“KPIs”). There is a need to easily adjust or tune one or more of these factors to predict the impact to the bottom line travel cost. Such a forward looking, predictive assessment may be helpful in identifying cost saving opportunities and implementing methods of achieving the same.

In various embodiments, systems and methods described herein allow for the predictive modeling of organizational procurement and spend. For example, a dashboard may be created and used to adjust, tune, or otherwise alter various cost inputs (such as opportunity assessment data and benchmark data) to produce a potential cost result (such as potential cost savings). In this manner, an organization may tune its travel budget so as to meet certain desired KPIs.

A dashboard may comprise a graphical interface for the display, adjustment, and prediction of organizational spend and procurement. For example, a dashboard may have various graphical user interface features, such as graphs, charts, and dials as well as sliding bars and number fields. Any of such features may be color coded for ease of use or to indicate additional information. A dashboard's bars, dials, number fields, or other interface features may be adjusted, for example, by software, hardware and/or a user. Responsive to such adjustment, other features of the dashboard may be updated (automatically or manually) in accordance with the adjustment. For example, adjustments to a KPI related to client data may result in a modeling operation to yield a comparison of a projected KPI target to a benchmark and a potential cost result.

A dashboard may obtain input data from various sources, such as client data (also referred to herein as opportunity assessment data), benchmark data, organizational cost data, procurement contract data, and budget data, though any type of data is contemplated herein. A dashboard may use the input data to form a variety of output data, such as a predicted organizational cost data, and/or potential cost result data.

Client data may include any data derived from an organizational client or sub-organization of a client, such as from a corporate travel department. Client data may be obtained during a client assessment, and accordingly, be referred to as opportunity assessment data. For example, opportunity assessment data may comprise organizational travel policy data (also referred to as policy opportunities), procurement contract data (also referred to as procurement opportunities), and behavioral data (also referred to as behavior opportunities).

Organizational travel policy data may include any policy rule or directive that directs or influences travel decisions. An organizational travel policy may be an absolute imperative, but in various embodiments, organizational travel policy data may be suggestive rather than an absolute imperative. For example, a organizational travel policy may be the percentage of organizational trips that include a Saturday night stay, percentage of car rentals that include a monthly (often reduced) rate rental agreement, a suggestion or requirement that all travelers book at least two weeks in advance, a suggestion or requirement that all travelers travel coach class during air travel, a suggestion or requirement that all travelers use an “economy” hotel, a suggestion or requirement that all travelers rent “economy” level cars (e.g. CHEVY AVEO or FORD FOCUS), a suggestion or requirement that all travelers use public transportation over private car service where possible and prudent, and/or that travelers fly into “secondary” airports in major markets where possible (e.g., flying into Islip instead of LaGuardia, Midway instead of O'Hare, and/or Love Field instead of Dallas-Fort Worth). Further, in various embodiments, an organizational travel policy may be partially suggestive. A partially suggestive organizational travel policy may initially set a parameter to one state, but may alter the parameter if certain conditions are met. For example, a suggestion or requirement that all travelers rent “economy” level cars (e.g., CHEVY AVEO or FORD FOCUS) may be overridden in the event certain conditions are met. In such an example, if a sales person intended on taking a client in a rental car, an upgrade to a larger and/or more luxurious vehicle may be approved.

Procurement contract data may comprise data relating to various procurement agreements an organization may have with various travel vendors. For example, an organization may agree to provide a certain level of spend for a given time period to a travel provider (e.g. airline, rental car company, or hotel company) in return for a group discount or “preferred” services (e.g. monthly car rental rates, car rental insurance, entrance into “elite” airport lounges, express check-out/check-in, or complimentary product upgrades). Procurement contract data may include certain benefits when spend reaches predetermined milestones, and/or the use of “preferred” air, car, taxi, hotel, bus and rail vendors. Procurement contract data may further include enhanced discounts for various upgrades. Procurement contract data may include contract data for any type of travel vendor, including airline, car rental company, hotel company, bus company, or rail line.

Behavioral data may comprise data regarding the behavior of travelers. While an organizational policy may suggest certain practices, behavioral data relates to actual choices travelers have made. For example, behavioral data include percentage of travelers who book online, percentage of travelers who use refundable fares, percentage of travelers who book a given time period in advance, percentage of travelers who manage meeting spend below a given level, the percentage of travelers who travel in classes other than coach, and/or any percentage of travelers who comply with any organizational travel policy.

Benchmark data includes any data relating to an organization's competitors or other comparable organizations, such as travel data. Benchmark data includes data derived from comparable organizations (such as organizations within an industry). Benchmark data may include other organizations individually, or it may be a composite or aggregate of an industry, such as industry means, modes, and medians. For example, benchmark data may include travel data derived from a group of large consulting firms. For example, benchmark data may include the total amount of travel spend, the total number of advanced airfare bookings, the total number of economy car rentals, and the total number of online bookings associated with a group of large consulting firms. Also for example, benchmark data may include average costs incurred by an industry for various travel services.

Budget data includes potential and/or proposed budgets for an organization or a subunit of an organization. For example, a travel department may have set budget data for a given period of time. Budget data may be a total aggregate number, and may also include more granular data, such as a budget for air travel, a budget for hotel stays, etc.

Organizational cost data includes historical organizational costs associated with an organization or a subunit of an organization, such as travel department. For example, organizational cost data may comprise the costs associated with travel activity for a given period of time, including travel destinations, travel routes, and other travel information.

A dashboard may receive client data, benchmark data, organizational cost data, procurement contract data, and/or budget data, and display such data via a graphical interface. Further, a dashboard may display predicted spend data. A dashboard may have a variety of graphical tools and features, sometimes referred to as “widgets,” that allow a user to adjust, tune, or modify various parameters. These parameters include, for example, projected or predicted changes in policy data, behavioral data, and procurement data. Responsive to such adjustment, the dashboard may model potential cost reduction data based upon benchmark data and/or procurement data. For example, modeling may comprise comparing client data to benchmark data. A potential cost result (e.g. a potential cost reduction), based upon the modeling, reflects the potential cost difference associated with a given change in a parameter.

In such a manner, potential cost results may be calculated responsive to various proposed or potential changes in the policy data, behavioral data, and/or procurement data. The same potential cost result may be realized in a variety of ways. For example, a given increase in compliance with a policy on fare class may achieve the same potential cost reduction as negotiated procurement contract having substantial discounted rates. A dashboard renders this nearly immediately apparent, so that an organization may make an appropriate decision quickly.

Modeling may comprise using client data (e.g., opportunity assessment data), an input variable (e.g., a user adjusted value) and benchmark data to achieve a potential cost result. For example, if an adjustment is made to reduce the number of first class airfares, modeling may comprise calculating the average difference in price between a coach fare and first class fare across a number of airlines or calculating the difference in price between a coach fare and first class in accordance with procurement data, and multiplying by the projected number of flights desired. In various embodiments, modeling may comprise adjusting an input variable, such as contract compliance, to predict or project a potential cost result. Modeling may further include making a comparison to benchmark data to illustrate any differences. A cost result may comprise a cost savings or overage, depending upon the adjusted input variable.

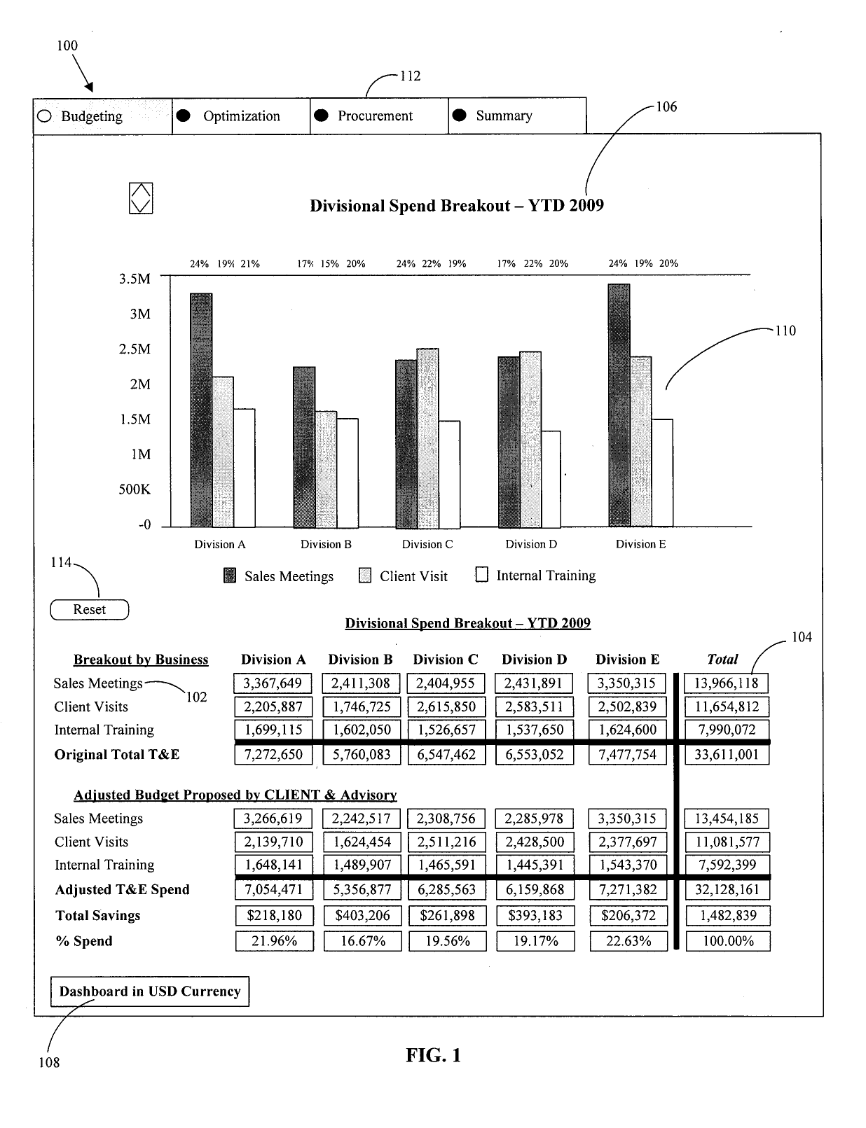

With reference to FIG. 1, exemplary dashboard display 100 is shown. Exemplary dashboard display 100 illustrates a divisional spend breakout for a given year. Divisional spend may comprise spend of a business subunit, such as a department or subsidiary. Tabs 112 may provide access to different data and tools. Divisional breakout graph 110 illustrates spend by division by spend category in a graph form. Any graph form may be used, such as bar graph, pie graph, line graph, or the like.

All or part of the information in divisional breakout graph 110 may be displayed in data windows 104. Data windows 104 may display data associated with spend category 102. Data windows 104 may display any form of data, such as a percentage of a total, a currency amount, or any other numerical amount. Spend category 102 may be any category selected by the business. In various embodiments, the business or user may select from any variety of spend category. For example, spend categories may comprise business meetings, business development meetings, product support visits, client service visits, deliveries, vendor/supplier meetings, and tradeshow/professional organization events. For example, spend category 102 may be the number of client visits, internal training, and sales meetings.

Data in data windows 104 may be changed by a user. Responsive to this change, other data in data windows 104 and/or divisional breakout graph 110 may change as well. For example, if one desired to know what divisional breakout graph 110 would look like if, for example, the number of sales visits were decreased by twenty percent in the next quarter, one would be able to alter data in data windows 104 and, in various embodiments, data windows 104 would be recalculated and repopulated. In further embodiments, a button or other toggle mechanism may be used to trigger the recalculation and repopulation. Label 108 may depict data source. Data in data windows 104 may be reset to default values by pressing reset button 114.

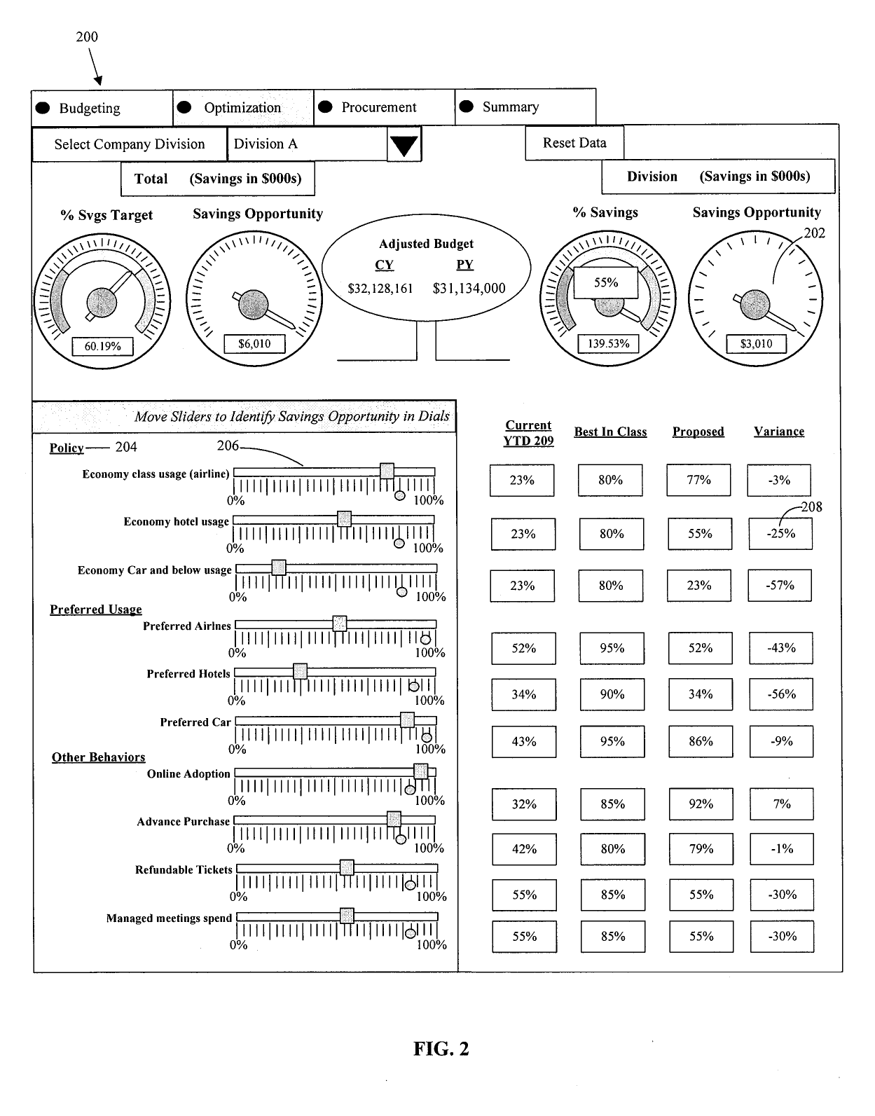

With reference to FIG. 2, exemplary dashboard display 200 is shown. FIG. 2 illustrates various procurement data, policy data, and behavioral data as sliding “bars” that may be adjusted. For example, category 204 (e.g., “Policy” and “Preferred Usage”) appears in exemplary dashboard display 200. Subcategories are shown beneath each these categories. Each subcategory has an associated bar 206. Bar 206 may be populated initially using historical data and, in various embodiments, bar 206 may be adjusted to select a predicted or projected level.

Data 208 displays “best in class” benchmark data, along with present costs, proposed changes, and the variance between the two. Data 208 may change responsive to adjustments of bar 206. Accordingly, an adjustment of bar 206 may cause a recalculation and repopulation of data 208. Further the dial 202 indicate various metrics that measure business performance.

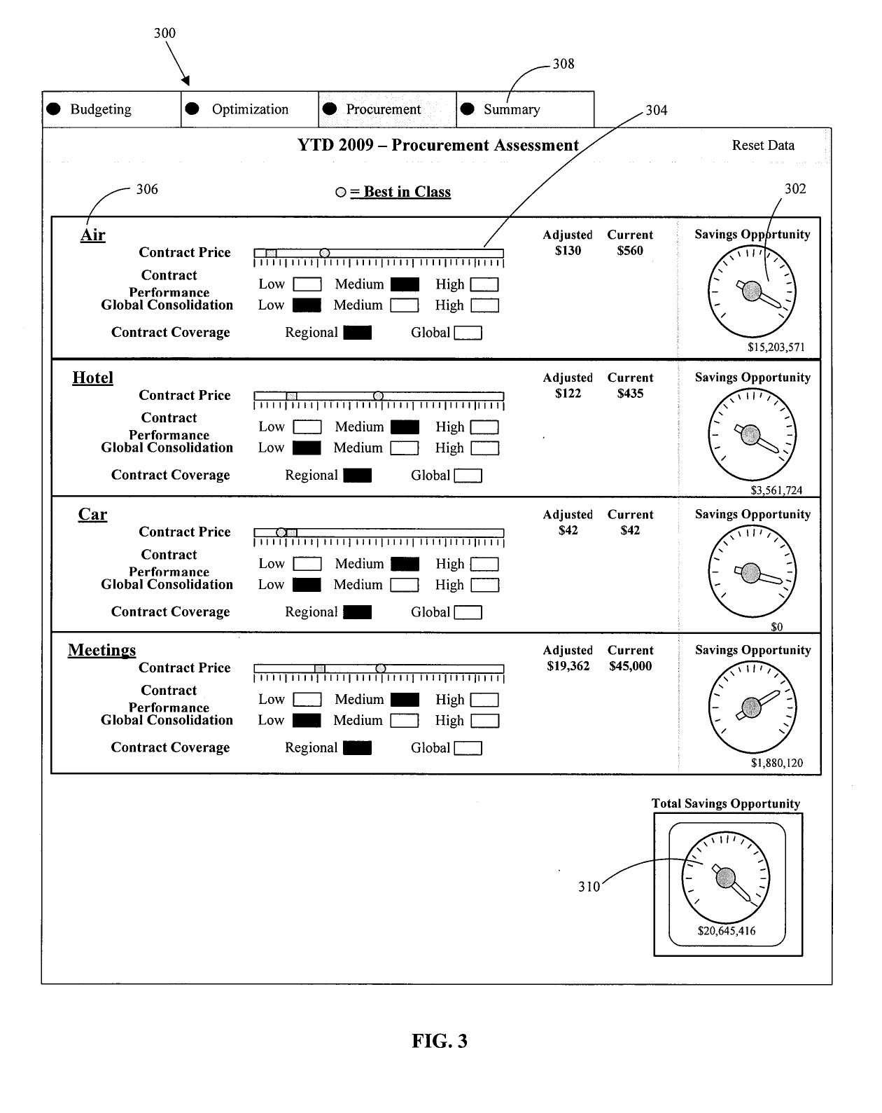

With reference to FIG. 3, exemplary dashboard display 300 is shown. FIG. 3 illustrates various procurement data by vendor type 306. Vendor type 306 may include air, hotel, car, etc. Bar 304 may be used to indicate and/or adjust a level of contract compliance. Initially, bar 304 may be populated using historical data and then adjusted to reflect projected or predicted data. Dial 302 may indicate a savings opportunity associated with the corresponding level of contract compliance. The savings that result from multiple adjustments to bar 304 in total may be shown in dial 310. Further, a savings in dollar amount may be shown as well. A tab may be used to assist in navigation. For example, tab 308 may navigate to a summary page or screen.

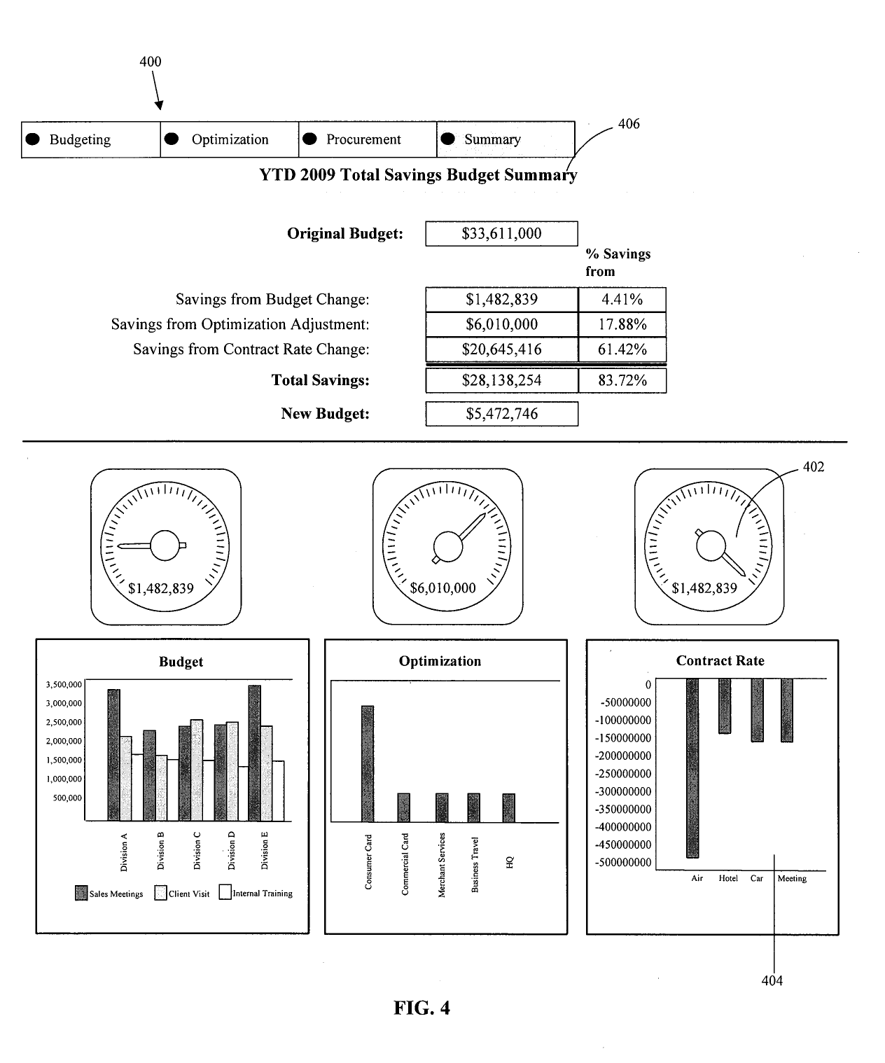

With reference to FIG. 4, exemplary dashboard display 400 is shown. FIG. 4 illustrates a “big picture” summary of the various adjustments made in other portions of the dashboard. Budget, optimization, and contract rate may be shown in a dial, such as dial 402. Budget, optimization, and contract rate may also be shown in a graph such as graph 404. For comparison purposes, a total savings 406 may be displayed with other relevant cost data.

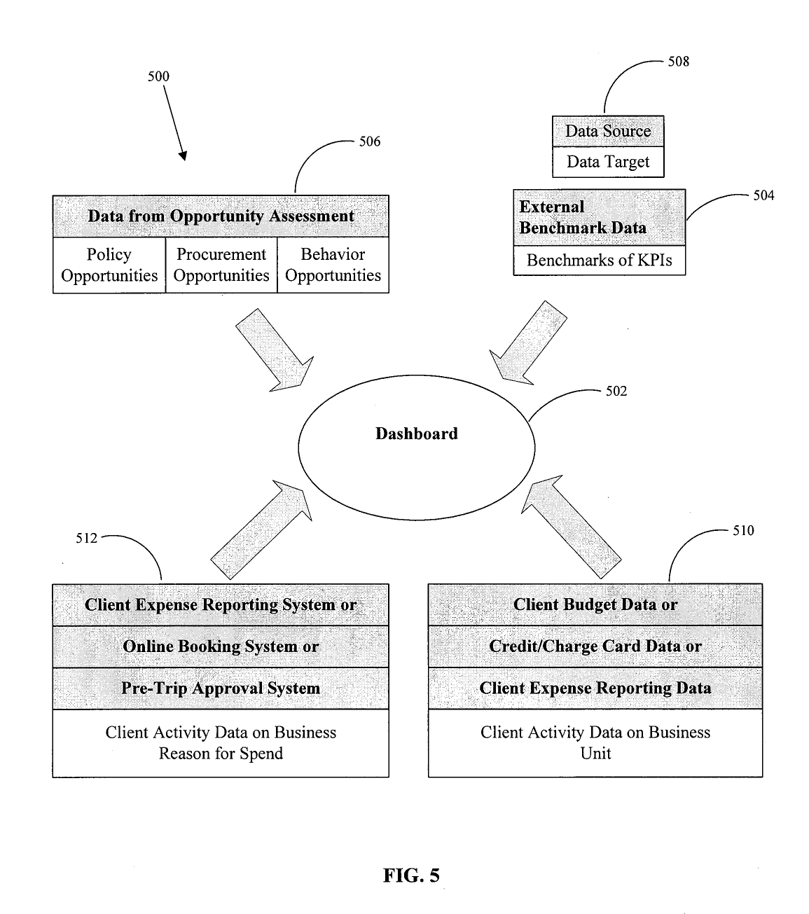

With reference to FIG. 5, exemplary data map 500 is shown. As described in key 508, data sources and data targets are shown in exemplary data map 500. Dashboard 502 is shown deriving data from several sources. Dashboard 502 may synthesize data as described above. Opportunity assessment 506 is illustrated where policy data, procurement data, and behavior data are derived from an organization. An opportunity assessment 506 may be conducted in a consulting-type arrangement between a consultant and an organization. Opportunity assessment 506 may comprise an audit or data extract of an organization's spending data.

External benchmark data 504 may be derived from proprietary data (e.g., American Express databases), a consulting group or other information provider. External benchmark data 504 is shown as the basis for benchmark data (i.e, KPIs). Behavioral data 512 that includes historical travel data (e.g. flights taken, the purpose of the travel, etc.) may be derived from organization expense reports, online booking systems, and pre-trip approval systems. Organizational costs 510 may be derived from organizational charge/credit cards, budgets, or expense reports.

In various embodiments, the system and methods described herein may be used in conjunction with an integrated travel industry system. An integrated travel industry system may comprise an integrated travel network having one or more centralized hub sites, at least one Global Distribution System connected to each of the hub sites, and at least one point of service terminal also connected to one of the hub sites. The integrated travel industry system may further comprise a translation server configured to connect to at least one Global Distribution System. The translation server may include contract compliance data and contract data embodied in a configuration item. Further, the translation server may route travel requests to a particular Global Distribution System based upon a comparison of the contract data and the compliance data. For additional examples of the features and functions of an integrated travel industry system, see for example, U.S. Ser. No. 11/468,241 filed on Aug. 26, 2006 entitled “System And Method For Processing Trip Requests,” the entire disclosure of which should be considered as being part of the disclosure of this application and are hereby incorporated herein by reference.

In various embodiments, the system and methods described herein may also incorporate the use of model dependencies and the impact of certain model changes on other models. The system and method may provide analytic information concerning models and the distribution of model variables to provide a holistic understanding into model relationships and dependencies. The system includes empowerment tools intended to cultivate, share and leverage knowledge, ideas and best practices, accelerate time to develop and deploy models, reduce time to execute campaigns, analyze model usage and trends, monitor data quality and system performance, and diagnostics for these items.

Through a number of interfaces, the invention encompasses model and model variable analysis within three primary groups; model insight, model analysis, and model reports. The system accepts inputs from a user in the form of model and/or variable search or selection criteria, retrieves information relating to models corresponding to the search criteria, and provides a visual representation of model and/or variable attributes within tables or graphs. The user may interact with the system via a web interface to view model dependencies, metadata reports, model analysis summary reports, model analysis detailed reports, model analysis chart reports, model analysis graph report, variable usage by business unit, variable count reports, variable usage by model type, variable metadata reports, model usage, penetration of models in campaigns, types of decision sciences used in customer marketing, human resource allocation, and system performance reports in tabular and graph form.

The system maintains up-to-date information relating to models and model variables within a number of database tables. These tables maintain information relating to models, model summaries, model owners, model dependencies, variables, variable classes, variable types, and/or the like. The system provides a utility to query the various tables in response to a request from a user, format query results according to user preferences or parameters, and provide the data to the requesting user within a web page. For additional examples of the features and functions of the system and method, see for example, U.S. Ser. No. 11/564,341 filed on Nov. 29, 2006 entitled “Method And Computer Readable Medium For Visualizing Dependencies Of Simulation Models,” the entire disclosures of which should be considered as being part of the disclosure of this application and are hereby incorporated herein by reference.

In various embodiments, the methods described herein are implemented using the various particular machines described below. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the various systems and methods may be implemented using CRYSTAL REPORTS and XCELSIUS, available from SAP AG through SAP America Inc., 3999 West Chester Pike, Newtown Square, Pa. 19073, USA. In various embodiments, the various systems and methods may be implemented using various products offered by MicroStrategy, Inc., 1861 International Drive, McLean, Va. 22102, USA, such as MICROSTRATEGY INTELLIGENCE SERVER and various software modules made for use with the same. For example, in various embodiments, a dashboard computer may comprise a processor, a memory, and a data store, wherein MICROSTRATEGY INTELLIGENCE SERVER, CRYSTAL REPORTS and/or XCELSIUS may execute.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, 95/98/2000, XP, Vista, 7, OS2, UNIX, Linux [e.g., Red Hat], Solaris, MacOS, etc.) as well as various conventional support software and drivers typically associated with computers. A user may include any individual, business, entity, government organization, software and/or hardware that interact with a system. A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, and/or the like. Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile/Vista/XP/7, OS2, UNIX, Linux, Solaris, BlackBerry OS, MacOS, PalmOS, iPhone OS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

As used herein, the term “network” includes any electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schreier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

Each participant may be equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

The process flows and screenshots depicted are merely embodiments and are not intended to limit the scope of the invention as described herein. For example, the steps recited in any of the method or process descriptions may be executed in any order and are not limited to the order presented.

Computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. Reference to an element in the singular is not intended to mean “one and only one” unless explicitly so stated, but rather “one or more.” Moreover, where a phrase similar to ‘at least one of A, B, and C’ is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the disclosure. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method comprising:
obtaining benchmark data;
obtaining opportunity assessment data; and
modeling the opportunity assessment data in comparison to the benchmark data.

2. The method of claim 1, further comprising obtaining organizational cost data.

3. The method of claim 2, further comprising obtaining an input variable and determining a potential cost result based upon the input variable and the opportunity assessment data.

4. The method of claim 3, further comprising displaying the potential cost result in a dashboard.

5. The method of claim 3, wherein the input variable comprises a predicted change in organizational contract compliance.

6. The method of claim 2, wherein the opportunity assessment comprises behavior opportunities.

7. The method of claim 3, further comprising adjusting the input variable and determining a new potential cost result based upon the adjusted input variable and the opportunity assessment data.

8. An article of manufacture including a computer readable medium having instructions stored thereon that, if executed by a computing device, cause the computing device to:
obtain benchmark data;
obtain opportunity assessment data; and
model the opportunity assessment data in comparison to the benchmark data.

9. The article of claim 8, further causing the computing device to obtain organizational cost data.

10. The article of claim 9, further causing the computing device to obtain an input variable and determine a potential cost result based upon the input variable and the opportunity assessment data.

11. The article of claim 10, further causing the computing device to display the potential cost result in a dashboard.

12. The article of claim 10, wherein the input variable comprises a predicted change in organizational contract compliance.

13. The article of claim 9, wherein the opportunity assessment comprises behavior opportunities.

14. The article of claim 10, further causing the computing device to adjust the input variable and determine a new potential cost result based upon the adjusted input variable and the opportunity assessment data.

15. A system comprising:
a dashboard computer having a processor, a memory, and a data store,
wherein the dashboard computer is configured to obtain, using the processor, benchmark data,
wherein the dashboard computer is configured to obtain, using the processor, opportunity assessment data,
wherein the dashboard computer is configured to model, using the processor, the opportunity assessment data in comparison to the benchmark data.

16. The system of claim 15, wherein the dashboard computer is further configured to obtain, using the processor, organizational cost data.

17. The system of claim 16, wherein the dashboard computer is further configured to obtain, using the processor, an input variable and determine, using the processor, a potential cost result based upon the input variable and the opportunity assessment data.

18. The system of claim 17, wherein the dashboard computer is further configured to display, using the dashboard computer, the potential cost result in a dashboard.

19. The system of claim 17, wherein the input variable comprises a predicted change in organizational contract compliance.

20. The system of claim 16, wherein the opportunity assessment comprises behavior opportunities.
